(19) United States
(12) Patent Application Publication
(10) Pub. No.: US 2009/0277574 A1
(43) Pub. Date: Nov. 12, 2009

(54) PATTERN TRANSFER METHOD

(75) Inventors: Shinobu SUGIMURA, Yokohama-shi (JP); Seiji MORITA, Yokohama-shi (JP); Akiko YUZAWA, Yokohama-shi (JP); Masatoshi SAKURAI, Tokyo (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/463,860

(22) Filed: May 11, 2009

(30) Foreign Application Priority Data
May 12, 2008 (JP) 2008-125225

(51) Int. Cl. B32B 37/10

(52) U.S. Cl. 156/247

(57) ABSTRACT

According to one embodiment, a pattern transfer method includes spin-coating one surface of a medium substrate with photopolymer having viscosity of 10 cps or less to form an photopolymer layer having a thickness of 200 nm or less, bonding the one surface of the medium substrate and the patterned surface of the first transparent stamper under vacuum with the photopolymer layer sandwiched therebetween, applying an ultraviolet ray to the photopolymer layer through the first transparent stamper to cure the photopolymer layer, and peeling off the first transparent stamper to form the photopolymer layer to which patterns of protrusions and recesses are transferred on the one surface of the medium substrate to control a thickness of the photopolymer layer remaining in recesses to 100 nm or less.

### CROSS-REFERENCE TO RELATED APPLICATIONS

This application is based upon and claims the benefit of priority from Japanese Patent Application No. 2008-125225, filed May 12, 2008, the entire contents of which are incorporated herein by reference.

### BACKGROUND

1. Field

One embodiment of the present invention relates to a pattern transfer method using ultraviolet curing resin (2P resin: photopolymer). In particular, the invention relates to a method for transferring patterns of a transparent stamper having patterns of protrusions and recesses to a substrate for a recording medium.

2. Description of the Related Art

In recent years, according to the improvement of recording density of information recording media, marks to be recorded on the media are further miniaturized. In order to facilitate formation of fine recording marks, a microprocessing technique for forming patterns of protrusions and recesses of about 100 nm or less on recording media is required. As such a microprocessing technique, the following method is considered. In this method, formation of fine patterns using lithography such as electron beam (EB) lithography or focused ion beam (FIB) lithography and transfer of the fine patterns to medium substrates using nano imprint lithography (NIL) are combined.

On the other hand, as a medium technique which seeks high recording density, for example, a magnetic recording system which uses a discrete track recording (DTR) medium having data zones and servo zones is known (Jpn. Pat. Appln. KOKAI Publication No. 2004-110896).

An example of a method for manufacturing a DTR medium will be schematically described with reference to FIGS. 1A to 1F. A magnetic layer 12 is deposited on a substrate 11, and a resist 21 is applied thereto (FIG. 1A). A stamper 31 having patterns of protrusions and recesses is prepared, and the patterned surface of the stamper 31 is opposed to the resist 21, and the patterns of the stamper 31 are transferred to the resist 21 by imprinting (FIG. 1B). Resist residues remained in recesses of the resist 21 are removed by reactive ion etching using oxygen gas (FIG. 1C). The patterned resist 21 is used as a mask, and the magnetic layer 12 is etched by ion milling (FIG. 1D). The remaining resist 21 is peeled off by oxygen ashing (FIG. 1E). The recesses are filled with a nonmagnetic material as needed, and a protective film 13 is formed on the entire surface to manufacture a DTR medium (FIG. 1F).

A high-pressure imprint method, for example, is considered as the imprint method used in FIG. 1B (Jpn. Pat. Appln. KOKAI Publication No. 2003-157520).

The imprint method includes the following three types of methods.

1) Thermal Imprint Method

This imprint method is excellent in mass productivity because a Ni stamper can be used for a mold. Since both the substrate to be imprinted and the mold are heated and cooled so that imprint is carried out, however, rise and fall in temperature takes a long time and a throughput cannot be increased, and thus this method is considered to be unsuitable for mass production. This is because the mold and a support of the mold have large heat capacity and thus it takes a long time for heating and cooling. Therefore, a mechanism which forcibly cools the support of the mold is provided to an apparatus, but the mechanism becomes large. In order to satisfactorily transfer patterns with a nanometer size to a large area, a die designed so that its entire surface can be uniformly imprinted is required, but it is difficult to incorporate a forcible cooling mechanism into such a specially designed die.

2) High-Pressure Imprint Method

This imprint method is also excellent in mass production because a Ni stamper can be used for a mold. Since it is not necessary to incorporate a special mechanism into an apparatus, a special die (mold support) which can satisfactorily transfer patterns with a nanometer size to a large area can be used. However, a high pressure is necessary for transferring patterns satisfactorily, and the Ni stamper itself might be deformed. Since a resist is elastically deformed, it takes about one minute until complete deformation is finished by imprint.

3) Optical Imprint Method

This imprint method is for imprinting photopolymer using a mold which transmits light (quartz, diamond or the like), and is excellent in shape transfer properties and throughput. However, it is difficult to manufacture the mold which transmits light.

As NIL, various methods are considered based on the above three methods and combinations thereof. However, particularly 1) the thermal imprint method and 2) the high-pressure imprint method have unsatisfactory throughput.

Optical disks such as CD (compact disk) and DVD (digital versatile disk) require a large capacity, and optical disks having multi-layered structure is being developed. In order to manufacture the optical disks having the multi-layered structure, the following method is disclosed (Jpn. Pat. Appln. KOKAI Publication No. 2003-281791). In this method, a resin transparent substrate which is manufactured from a Ni stamper by injection molding, and a resin transparent stamper which is manufactured by injection molding are bonded with a 2P resin sandwiched therebetween. After an ultraviolet ray (UV) is applied to cure the 2P resin, the transparent stamper is peeled off in a state that patterns are transferred, on which a medium film having a thickness of several tens μm and a multi-layered structure is formed. Such an optical disk manufacturing method does not have a step of etching the medium film, and thus a problem caused by the etching does not arise.

In order to manufacture a DTR type medium, a magnetic layer is processed by using a resist as a mask to which patterns are transferred from a stamper. Thus, taking the processing time reduction for removing resist residues into consideration, the resist should be thinned. In hard disk drives (HDD) into which the DTR medium is incorporated, the patterns are desirably capable of being formed on both surfaces of a substrate so that read and write can be carried out on both surfaces of the medium. In the conventional methods, however, it is difficult to satisfy these demands.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIGS. 1A to 1F are cross-sectional views illustrating an example of a method of manufacturing a DTR medium;

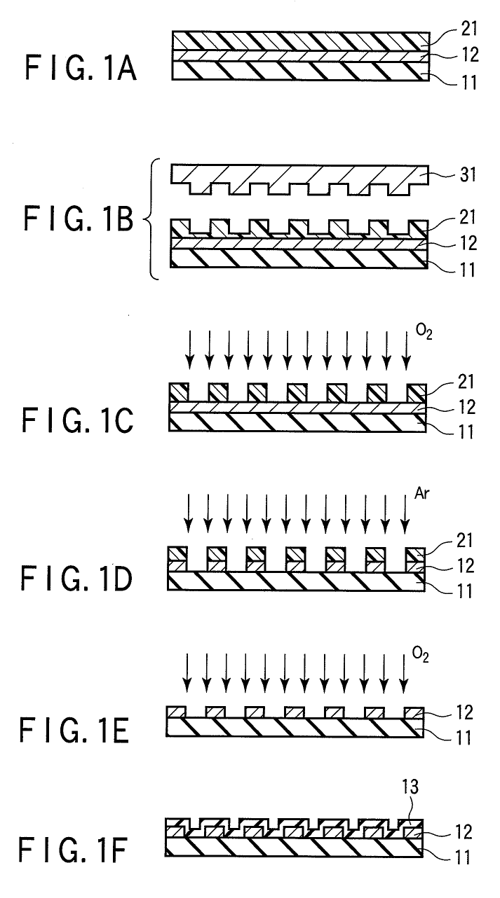

FIGS. 2A to 2D are schematic diagrams illustrating a pattern transfer method according to the present invention;

FIGS. 3A to 3D are cross-sectional views illustrating the pattern transfer method according to Example 1;

FIGS. 4A to 4D are cross-sectional views illustrating the pattern transfer method according to Example 1; and

FIGS. 5A and 5D are cross-sectional views illustrating the pattern transfer method according to Example 2.

### DETAILED DESCRIPTION

Various embodiments according to the invention will be described hereinafter with reference to the accompanying drawings. In general, according to one embodiment of the invention, there is provided a pattern transfer method comprising: spin-coating one surface of a medium substrate or a patterned surface of a first transparent stamper having patterns of protrusions and recesses, or both the one surface of the medium substrate and the patterned surface of the first transparent stamper with photopolymer having viscosity of 10 cps or less to form an photopolymer layer having a thickness of 200 nm or less; bonding the one surface of the medium substrate and the patterned surface of the first transparent stamper under vacuum with the photopolymer layer sandwiched therebetween; applying an ultraviolet ray to the photopolymer layer through the first transparent stamper to cure the photopolymer layer; and peeling off the first transparent stamper to form the photopolymer layer to which patterns of protrusions and recesses are transferred on the one surface of the medium substrate to control a thickness of the photopolymer layer remaining in recesses to 100 nm or less. In the present invention, were the patterns of protrusions and recesses are transferred to the both surfaces of the medium substrate, the above method may be performed sequentially on one surface and the other surface of the medium substrate, or the above method may be performed simultaneously on both surfaces of the medium substrate.

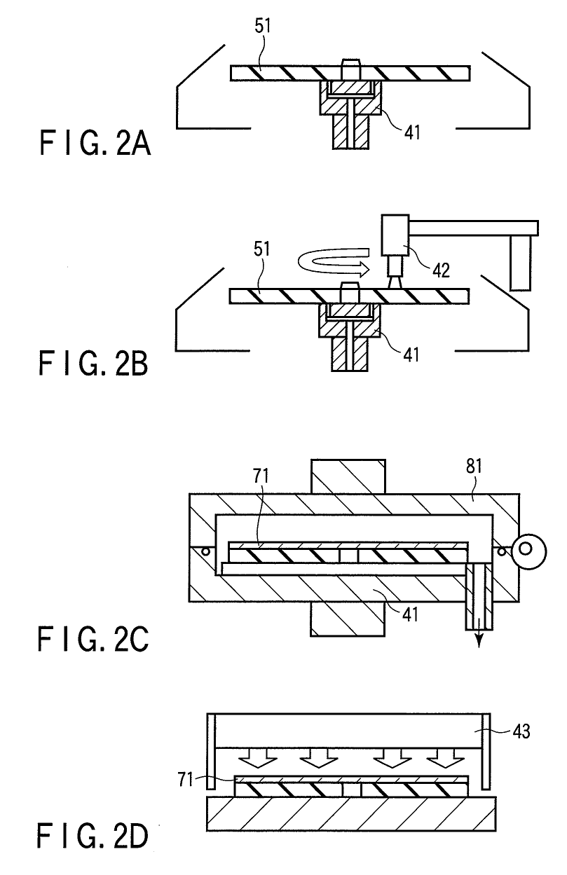

A pattern transfer method according to the present invention will be schematically described below with reference to FIGS. 2A to 2D. These drawings illustrate a case where a pattern is transferred to one surface of a medium substrate. As shown in FIG. 2A, a medium substrate 51 is placed on a spinner 41. As shown in FIG. 2B, while the medium substrate 51 is being spun together with the spinner 41, photopolymer (ultraviolet curing resin) is dropped from a dispenser 42 for spin-coating the medium substrate 51. As shown in FIG. 2C, the one surface of the medium substrate 51 and a patterned surface of a first transparent stamper 71 are bonded under vacuum with a photopolymer layer (not shown) sandwiched therebetween in a vacuum chamber 81. As shown in FIG. 2D, UV from a UV light source 43 is applied through the first transparent stamper 71 under atmospheric pressure to cure the 2P resin layer. After the step in FIG. 2D, the first transparent stamper 71 is peeled off.

In the present invention, the one surface of the medium substrate or the patterned surface of the transparent stamper having patterns of protrusions and recesses, or both the one surface of the medium substrate and the patterned surface of the transparent stamper are spin-coated with photopolymer having viscosity of 10 cps or less to form an photopolymer layer having a thickness of 200 nm or less.

The viscosity of the photopolymer is set to 10 cps or less because of the following reasons. Spin speed of the spinner to be used for the spin coating of the photopolymer is generally about 10000 rpm at most. At the rotations of about 10000 rpm, when the viscosity of the photopolymer exceeds 10 cps, it is difficult to form the photopolymer layer having a thickness of 200 nm or less. The thickness of the photopolymer layer to be formed is 200 nm or less in order that the thickness of the photopolymer layer remaining in recesses after patterns of protrusions and recesses are transferred to the photopolymer layer is reduced as much as possible.

In the present invention, the one surface of the medium substrate and the patterned surface of the transparent stamper are bonded under vacuum with the photopolymer layer sandwiched therebetween. When the bonding under vacuum is used, air bubbles can be prevented from entering the photopolymer layer, and the photopolymer layer can be thinned.

On the other hand, after the photopolymer is applied to the medium substrate and the transparent stamper is bonded thereto, the photopolymer layer can be formed by high-speed spin. With this method, air bubbles or dust can be prevented from entering the photopolymer layer, but it is difficult to make the photopolymer layer thin.

In the present invention, when the one surface of the medium substrate and the patterned surface of the transparent stamper are bonded with the photopolymer layer sandwiched therebetween, a degree of vacuum may be set to 10³ Pa or less. When a vacuum chamber with small capacity is used, the vacuum of 10³ Pa or less can be achieved in about several seconds. At this time, only empty weight of the transparent stamper or the medium substrate may be applied to the photopolymer layer or a pressure may be applied thereto from the outside. Since the photopolymer is liquid before curing, the patterns can be transferred by maintaining it under vacuum for several seconds regardless of presence or absence of the external pressure.

In the present invention, when the transparent stamper is peeled off and the photopolymer layer to which the patterns of protrusions and recesses are transferred is formed on one surface of the medium substrate, the thickness of the photopolymer layer remaining in the recesses is made to be 100 nm or less. The thickness of the photopolymer layer remaining in the recesses is preferably 50 nm or less, and more preferably 30 nm or less.

According to the present invention, after the patterns of protrusions and recesses are transferred to the photopolymer layer on the medium substrate, the thickness of the photopolymer layer remaining in the recesses can be sufficiently controlled. Thus, the process time for removing residues of the photopolymer layer remaining in the recesses can be shortened. With the process time for removing residue shortened, the shapes of the patterns of the remaining photopolymer layer are satisfactorily maintained. Therefore, the underlying magnetic layer can be satisfactorily etched.

Embodiments of the present invention will be described below with reference to the drawings. The following examples describe a case where the patterns of protrusions and recesses are transferred to the photopolymer layer applied to both surfaces of the medium substrate to manufacture a DTR magnetic recording medium. The DTR magnetic recording medium has servo zones and data zones divided by the servo zones. A preamble section, an address section and a burst section are formed in the servo zones. Discrete tracks are formed in the data zones. The respective drawings are schematic diagrams for describing the present invention and promoting the understanding of the present invention. In the drawings, shape, dimension and ratio are different from actual ones, but they can be suitably changed based on the following description and well-known techniques.

### EXAMPLE 1

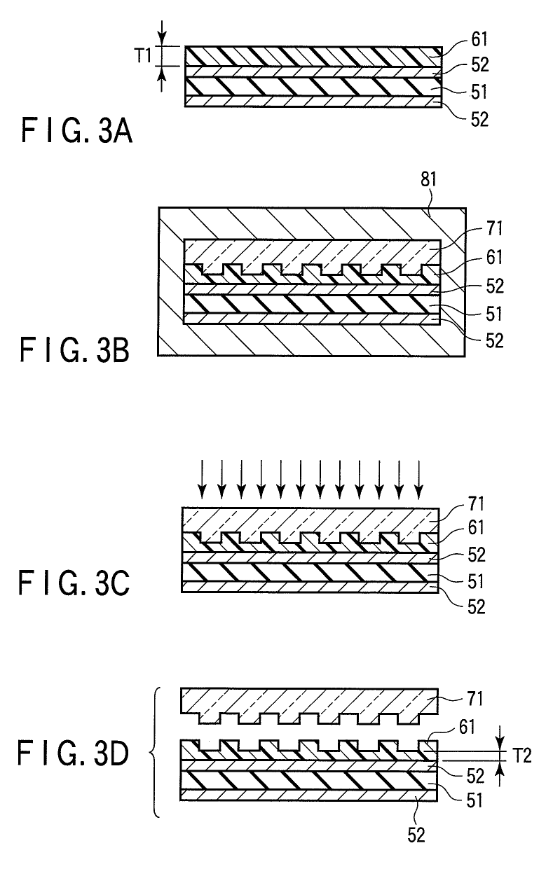

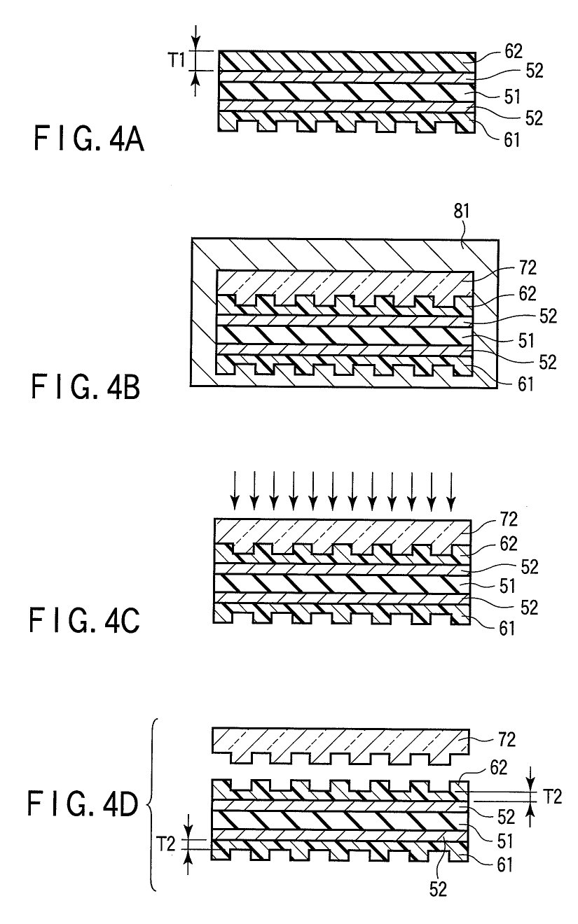

Example 1 describes a method for transferring the patterns of protrusions and recesses sequentially to one surface and the other surface of the medium substrate with reference to FIGS. 3A to 3D and FIGS. 4A to 4D.

As shown in FIG. 3A, a magnetic layer 52 was deposited on both surfaces of a doughnut-shape glass substrate 51 as the medium substrate. The magnetic layer 52 on one surface of the glass substrate 51 was spin-coated with ultraviolet curing resin (referred to as a 2P resin hereinafter) with viscosity of 5 cps so as not to cover a center hole. The ultraviolet curing resin magnetic was spun off at 10000 rpm for 30 seconds to form a 2P resin layer 61 with a thickness T1 of 60 nm.

As shown in FIG. 3B, a first resin transparent stamper 71 formed with the patterns of protrusions and recesses was prepared.

The transparent stamper was manufactured by the following method. A resist was applied to a master, and servo zones and data zones were drawn by electron beam lithography so that a resist master was fabricated. A positive resist was used as a resist, the resist having a thickness of 50 nm. The patterns of protrusions and recesses corresponding to the discrete tracks on the data zones had a track pitch (TP) of 100 nm (L/G=70 nm/30 nm) and a depth of 50 nm.

The resist master was subject to electroforming so that a Ni stamper for injection molding was manufactured. Any one of so-called a father stamper which is firstly manufactured from a master, a mother stamper which is replicated from the father stamper by electroforming and a son stamper which is replicated from the mother stamper by electroforming may be used as the Ni stamper.

The resin transparent stamper 71 was manufactured by injection molding using the Ni stamper. Polycarbonate (PC) may be used as a material of the transparent stamper 71. Taking mold releasing properties with respect to the 2P resin into consideration, however, cycloolefin polymer (COP), cycloolefin copolymer (COC) or polymethylmethacrylate (PMMA) is preferably used.

In a vacuum chamber 81, the one surface of the glass substrate 51 and the patterned surface of the first transparent stamper 71 were bonded with the 2P resin layer 61 sandwiched therebetween under vacuum of 10³ Pa or less.

As shown in FIG. 3C, vacuum was released, and UV was applied through the first transparent stamper 71 under atmospheric pressure to cure the 2P resin layer 61. The time required for curing depends on curing properties of polymerization initiator included in the used 2P resin and performance of a UV light source, but normally the curing is completed in several tens of seconds.

As shown in FIG. 3D, the first transparent stamper 71 was peeled off from the glass substrate 51, and the 2P resin layer 61 to which the patterns of protrusions and recesses was transferred was formed. A thickness T2 of the 2P resin layer 61 remaining recesses was 30 nm.

As shown in FIG. 4A, the magnetic layer 52 deposited on the other surface of the glass substrate 51 was spin-coated with the 2P resin with viscosity of 5 cps so as not to cover a center hole. The 2P resin was spun off at 10000 rpm for 30 seconds to form a 2P resin layer 62 with a thickness T1 of 60 nm.

As shown in FIG. 4B, a second resin transparent stamper 72 formed with the patterns of protrusions and recesses was prepared. In the vacuum chamber 81, the other surface of the glass substrate 51 and the patterned surface of the second transparent stamper 72 were bonded with the 2P resin layer 62 sandwiched therebetween under vacuum of 10³ Pa or less.

As shown in FIG. 4C, the vacuum was released, and UV was applied through the second transparent stamper 72 under atmospheric pressure to cure the 2P resin layer 62.

As shown in FIG. 4D, the second transparent stamper 72 was peeled off from the glass substrate 51, and the 2P resin layer 62 to which the patterns of protrusions and recesses was transferred was formed. A thickness T2 of the 2P resin layer 62 remaining in the recesses was 30 nm.

In this example, the glass substrate was coated with the 2P resin, but the patterned surface of the transparent stamper may be coated with the 2P resin, or both the glass substrate and the transparent substrate may be coated with the 2P resin.

### EXAMPLE 2

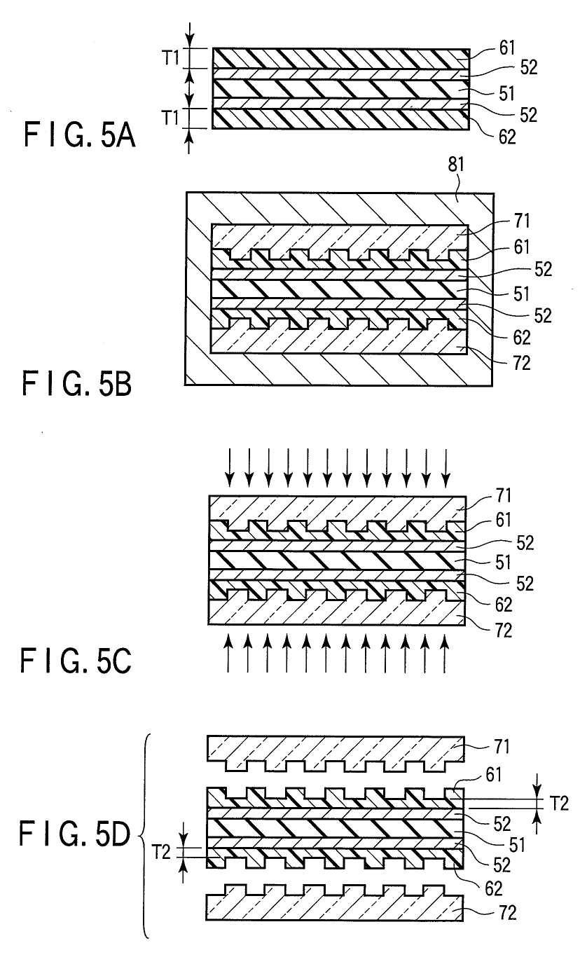

Example 2 describes a method for transferring patterns of protrusions and recesses to both the surfaces of the medium substrate at one time with reference to FIGS. 5A to 5D.

As shown in FIG. 5A, the magnetic layers 52 were deposited on both the surfaces of the doughnut-shape glass substrate 51 as the medium substrate. The magnetic layers 52 on both the surfaces of the glass substrate 51 were spin-coated with the 2P resin with viscosity of 5 cps so as not to cover a center hole. The 2P resin was spun off at 10000 rpm for 30 seconds to form 2P resin layers 61, 62 with a thickness T1 of 60 nm. The 2P resin layers on both the surfaces of the glass substrate 51 may be coated simultaneously using a double-faced spin coater, or each surface may be coated separately.

As shown in FIG. 5B, first and second resin transparent stampers 71, 72 formed with patterns of protrusions and recesses were prepared. One surface of the glass substrate 51 and the patterned surface of the first transparent stamper 71 were bonded with the 2P resin layer 61 sandwiched therebetween, and the other surface of the glass substrate 51 and the patterned surface of the second transparent stamper 72 were bonded with the 2P resin layer 62 sandwiched therebetween under vacuum of 10³ Pa or less in the vacuum chamber 81. At this time, the first and second transparent stampers 71, 72 may be bonded to the glass substrate 51 one by one, or they are bonded to both the surfaces of the glass substrate 51 simultaneously.

As shown in FIG. 5C, the vacuum was released, and UV was applied through the first transparent stamper 71 to cure the 2P resin layer 61, and UV was applied through the second transparent stamper 72 to cure the 2P resin layer 62 under atmospheric pressure.

FIG. 5C illustrates a case where UV is applied simultaneously from two light sources to the 2P resin layers 61, 62 on both the surfaces of the glass substrate 51, but the present invention is not limited to this case. For example, the inside of an UV irradiation chamber is mirror-finished so that UV can be applied from one light source to the 2P resin layers 61, 62 on both the surfaces of the glass substrate 51. Needless to say, UV may be applied sequentially to the 2P resin layers 61, 62 on both surfaces of the glass substrate 51 one by one.

As shown in FIG. 5D, the first and second transparent stampers 71, 72 were peeled off from the glass substrate 51, so that the 2P resin layers 61, 62 to which the patterns of protrusions and recesses were transferred were formed. A thickness T2 of the 2P resin layers 61, 62 remaining in the recesses was 30 nm. The first and second transparent stampers 71, 72 may be peeled off sequentially one by one. Alternately, an outer peripheral portion of the glass substrate 51 is held to fix, and the transparent stampers 71, 72 on both the surfaces can be peeled off approximately simultaneously.

### EXAMPLE 3

The 2P resin layers 61, 62 with thickness of 130 nm were formed on both the surfaces of the glass substrate 51, respectively, by the same method as in Example 2 except that a 2P resin with viscosity of 10 cps was used. Thereafter, the 2P resin layers 61, 62 to which patterns of protrusions and recesses were transferred were formed with the similar steps to those in Example 2. A thickness T2 of the 2P resin layers 61, 62 remaining in the recesses was 100 nm.

### COMPARATIVE EXAMPLE

The 2P resin layers 61, 62 with a thickness of 250 nm were formed on both the surfaces of the glass substrate 51, respectively, by the same method as in Example 2 except that a 2P resin with viscosity of 20 cps was used. Thereafter, the 2P resin layers 61, 62 to which patterns of protrusions and recesses were transferred were formed with the similar steps to those of Example 2. A thickness T2 of the 2P resin layers 61, 62 remaining in the recesses was 220 nm.

In Examples 1 to 3, the glass substrate 51 was spin-coated with the 2P resin having viscosity of 10 cps or less so that the 2P resin layer having a thickness of 200 nm or less is formed. The thickness of the 2P resin layer remaining in the recesses when the patterns of protrusions and recesses were transferred to the 2P resin layer can be 100 nm or less.

At this time, after the patterns are transferred to one surface like Example 1, the patterns can additionally be transferred also to the other 2P resin layer.

Takt times from the step of forming the 2P resin layer on both the surfaces of the glass substrate to the peeling step according to the method in Example 2 were measured, the results shown below. Formation of the 2P resin layer, conveyance of the substrate: 5 sec, release of vacuum in the vacuum chamber: 5 sec, bonding: 5 sec, conveyance: 2 sec, UV irradiation: 5 sec, conveyance: 5 sec, and peeling step. Total takt time was 27 seconds.

On the other hand, takt times from the step of forming the resist layer on both the surfaces of the glass substrate to the peeling step according to a conventional high-pressure imprint method were measured, the result shown below. Formation of the resist layer, conveyance of the substrate: 5 sec, high-pressure pressing operation: 5 sec, press retention: 60 sec, release of press: 5 sec, conveyance: 5 sec, and peeling step. Total takt time was 80 seconds.

In the method of the present invention, the time from the formation of the resin layer to the peeling step can be shortened to about one third in comparison with the conventional high-pressure imprint method.

In the method of the present invention, 10,000 or more of disposable transparent stampers can be manufactured from one Ni stamper by injection molding without deteriorating quality. On the other hand, in the high-pressure imprint method, at a time when the imprint is carried out at about 1000 times using one Ni stamper, the patterns are deformed. That is, in the method of the present invention, the number of media which can be manufactured by one stamper can be 10 or more times the conventional high-pressure imprint method.

The above has described the method for manufacturing a discrete track type magnetic recording medium including data zones and servo zones according to the present invention. However, the application is not limited to this, and the method of the present invention can be applied also to manufacturing of optical disks such as CD and DVD, semiconductor memories and the like.

The invention may be modified without departing from the scope of the invention described in the appended claims. The invention may be variously modified without departing from the gist at the stage of working. Further, various invention can be structured by suitably combining a plurality of constituent elements disclosed in the above embodiments.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A pattern transfer method comprising:
spin-coating either a first surface of a medium substrate or a first patterned surface of a first transparent stamper comprising patterns of convexity and concavity, or both the first surface of the medium substrate and the first patterned surface of the first transparent stamper with photopolymer comprising viscosity of 10 cps or less in order to form an photopolymer layer comprising a thickness of 200 nm or shorter;
bonding the first surface of the medium substrate and the first patterned surface of the first transparent stamper under vacuum comprising the photopolymer layer between the first surface and the first patterned surface;
applying an ultraviolet ray to the photopolymer layer through the first transparent stamper in order to cure the photopolymer layer; and
peeling off the first transparent stamper in order to form the photopolymer layer comprising patterns of convexity and concavity transferred on the first surface of the medium substrate in order to control a thickness of the photopolymer layer remaining in the concavity to 100 nm or shorter.

2. The method of claim 1, comprising:
spin-coating either the first surface of a medium substrate or the first patterned surface of a first transparent stamper comprising patterns of convexity and concavity, or both the one surface of the medium substrate and the first patterned surface of the first transparent stamper with photopolymer of viscosity of 10 cps or less in order to form an photopolymer layer comprising a thickness of 200 nm or shorter;
bonding the first surface of the medium substrate and the first patterned surface of the first transparent stamper under vacuum with the photopolymer layer between the first surface and the first patterned surface;
applying an ultraviolet ray to the photopolymer layer through the first transparent stamper in order to cure the photopolymer layer;
peeling off the first transparent stamper in order to form the photopolymer layer comprising patterns of convexity and concavity transferred on the first surface of the medium substrate in order to control a thickness of the photopolymer layer remaining in the concavity to 100 nm or shorter;
spin-coating either a second surface of the medium substrate or a second patterned surface of a second transparent stamper comprising patterns of convexity and concavity, or both the second surface of the medium substrate and the second patterned surface of the second transparent stamper with photopolymer of viscosity of 10 cps or less in order to form an photopolymer layer comprising a thickness of 200 nm or shorter;
bonding the second surface of the medium substrate and the second patterned surface of the second transparent stamper under vacuum with the photopolymer layer between the second surface and the patterned surface;
applying an ultraviolet ray to the photopolymer layer through the second transparent stamper in order to cure the photopolymer layer; and
peeling off the second transparent stamper in order to form the photopolymer layer comprising patterns of convexity and concavity transferred on the second surface of the medium substrate in order to control a thickness of the photopolymer layer remaining in concavity to 100 nm or less.

3. A pattern transfer method comprising:
spin-coating either both first and second surfaces of a medium substrate, a first patterned surface of a first transparent stamper comprising patterns of convexity and concavity and a second patterned surface of a second transparent stamper comprising patterns of convexity and concavity, or both the surfaces of the medium substrate and both the first and second patterned surfaces of the first and second transparent stampers with photopolymer of viscosity of 10 cps or less in order to form an photopolymer layer comprising a thickness of 200 nm or shorter;
bonding both the first and second surfaces of the medium substrate and the first and second patterned surfaces of the first and second transparent stampers under vacuum with the photopolymer layer between the surfaces;
applying an ultraviolet ray to the photopolymer layers through the first and second transparent stampers in order to cure the photopolymer layers; and
peeling off the first and second transparent stampers in order to form the photopolymer layers comprising patterns of convexity and concavity transferred on the both surfaces of the medium substrate, respectively, in order to control a thickness of the photopolymer layers remaining in the concavity to 100 nm or shorter.
